(19) United States
(12) Patent Application Publication
(10) Pub. No.: US 2020/0167573 A1
(43) Pub. Date: May 28, 2020

(54) METHOD AND APPARATUS FOR OBJECT DETECTION IN CAMERA BLIND ZONES

(71) Applicant: GM GLOBAL TECHNOLOGY OPERATIONS LLC, DETROIT, MI (US)

(72) Inventors: Xiaofeng F. Song, Novi (US); Paul A. Adam, MIlford (US); Gabriel T. Choi, Novi, MI (US); Dmitriy Feldman, West Bloomfield (US); Julius M. Vida, Brighton, MI (US)

(21) Appl. No.: 16/201,218

(22) Filed: Nov. 27, 2018

(51) Int. Cl. G06K 9/00; H04N 5/235

(52) U.S. Cl. CPC G06K 9/00791; G05D 1/0231; G05D 2201/0213; H04N 5/2355

(57) ABSTRACT

The present application generally relates to a method and apparatus for object detection within a camera blind spot in a motor vehicle. In particular, the system is operative to determine a potential blind spot in response to a location, adjust a dynamic range of a camera, and detect an object in response to the adjusted dynamic range.

### BACKGROUND

The present disclosure relates generally to cameras, and more particularly, includes cameras used on vehicles. More specifically, aspects of the present disclosure relate to systems, methods and devices for overcoming camera blackout or whiteout due to severe changes in lighting, such as shadows and bright lights by using location information and a camera with differing optical characteristics.

As autonomous vehicle, or automated driving assist features on vehicles, become more ubiquitous, compensating for differing lighting conditions will become necessary to ensure proper control and handling of the vehicle. Digital cameras employed by vehicular systems receive light through a lens and may convert the incoming light rays to an electronic signal for display, evaluation or storage of the images defined by the light rays. When used outdoors, the incoming light rays may be subject to intense lights sources such as the sun or another bright light source. When the light entering through the camera lens includes that from such a source, the ability to discern details of the surroundings may be degraded. Incumbent camera systems may auto adjust their aperture to control light reaching the image sensor, and therefore lower the impact of the intense light source. However, this would dim the image as a whole and may result in filtering out image details that are of importance.

For example, cameras for autonomous vehicle or automated driving assist systems may experience black and white out when entering and exiting from a tunnel or a strong shadow of building or hills. From these limitation, the object tracking often loses the target or experiences a degradation in tracking performance. This may lead to unwanted alerts or braking and customer dissatisfaction for camera only features. It would be desirable to overcome these problems in order to compensate for camera blind zones for vehicular camera.

The above information disclosed in this background section is only for enhancement of understanding of the background of the invention and therefore it may contain information that does not form the prior art that is already known in this country to a person of ordinary skill in the art.

### SUMMARY

Disclosed herein are object detection methods and systems and related control logic for provisioning vehicle sensing and control systems, methods for making and methods for operating such systems, and motor vehicles equipped with onboard sensor and control systems. By way of example, and not limitation, there is presented various embodiments of a camera system with configurable camera characteristics such as aperture and sensitivity are disclosed herein.

In accordance with an aspect of the present invention, an apparatus comprising a first camera for capturing a first image and a second image, wherein the first camera has a first adjustable parameter, a processor for receiving a location information indicative of a blind spot, generating a first control signal to adjust the first adjustable parameter in response to the location information, detecting an object within the second image and generating a second control signal in response to the object, and a vehicle controller for controlling a driving assisted vehicle in response to the second control signal.

In accordance with another aspect of the present invention an apparatus comprising a first camera having an adjustable dynamic range for capturing a first image and a third image, a global positing sensor for determining a current location, an image processor comparing the current location to a stored location, the image processor further operative to generate a control signal for adjusting the adjustable dynamic range in response to the comparison and controlling the capture of the third image, the image processor further operative for detecting an object within the second image and the third image, and a vehicle controller for controlling a vehicle in response to the detection of the object.

In accordance with another aspect of the present invention a method for comprising receiving a request for an activation of an assisted driving algorithm, capturing a first image with a first camera, receiving a location data, comparing the location data with a location stored in a memory, adjusting a first parameter on the first camera in response to the location, capturing a second image with the first camera, detecting an object within the second image, and controlling a vehicle in response to the detection of the first object.

The above advantage and other advantages and features of the present disclosure will be apparent from the following detailed description of the preferred embodiments when taken in connection with the accompanying drawings.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates an exemplary application of the method and apparatus for object detection in camera blind zones in a motor vehicle according to an embodiment of the present disclosure.

FIG. 2 shows a block diagram illustrating an exemplary system for object detection in camera blind zones in a motor vehicle according to an embodiment of the present disclosure.

FIG. 3 shows a flowchart illustrating an exemplary method for object detection in camera blind zones according to an embodiment of the present disclosure

The exemplifications set out herein illustrate preferred embodiments of the invention, and such exemplifications are not to be construed as limiting the scope of the invention in any manner.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

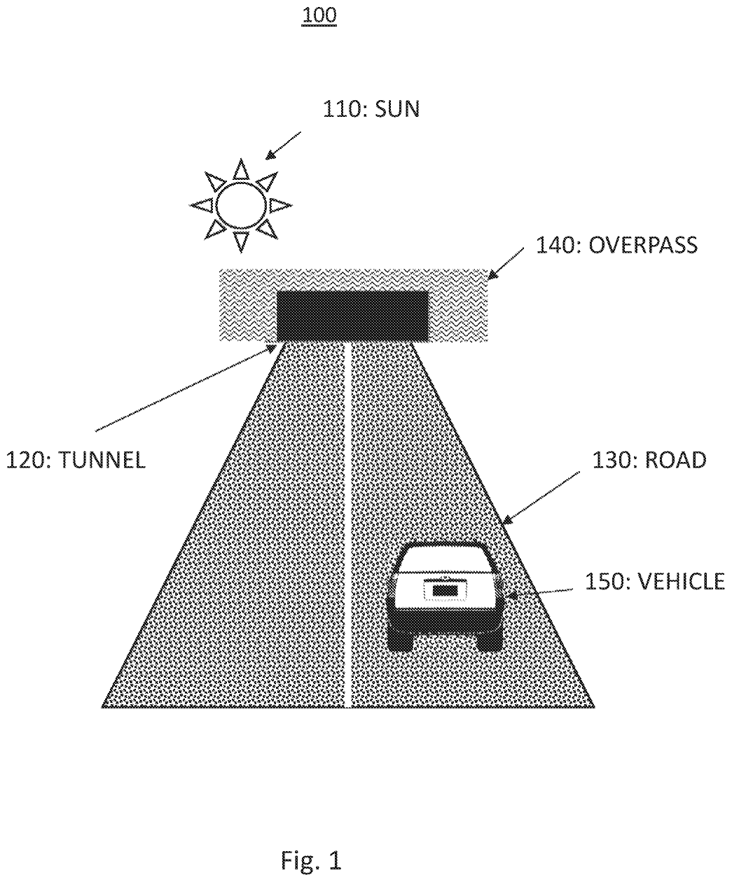

FIG. 1 schematically illustrates an exemplary application of the method and apparatus for object detection in camera blind zones in a motor vehicle 100 according to the present disclosure. In this exemplary embodiment, a vehicle 150 is traveling along a road 130 approaching a tunnel 120. The tunnel 120 may be under an overpass 140 or the like. In this exemplary embodiment, the sun 110 is in front of the vehicle at a low angle and therefore is within the field of view of any front mounted cameras installed on the vehicle 150. As the sun 110 is within the field of view of the cameras, the contrast to the light within the tunnel 120 is great and therefore anything within the tunnel may be dark to be detected by the camera. The driving assistance system in the vehicle may be tracking an object ahead of the vehicle 150, but as the object enters the tunnel 120, the camera loses sight of the object due to the darkness of the tunnel 120.

In the instance where an assisted driving system experiences black and white out conditions, the system may lose object tracking when entering and exiting from a tunnel or a strong shadow of building or hills. The system may then limit the autonomous features in response to the lack of object information. The exemplary system is operative to address the problem of losing tracked objects due to black out or white out which are caused by the camera by utilizing a stereo camera with differing characteristics for each camera. For example, one or more cameras may have infrared capabilities and the IR camera may be used to closely track objects around the beginning and end of the tunnel and shadow. In addition, the system may prepare the properties of at least one camera for the upcoming severe brightness change due to a tunnel or strong shadow from terrain or infra structure wherein the method is operative to fuse object information from those cameras. For example one camera may be set for low light detection and one for bright light detection. The method may then fuse the object information from each camera to maintain target object tracking.

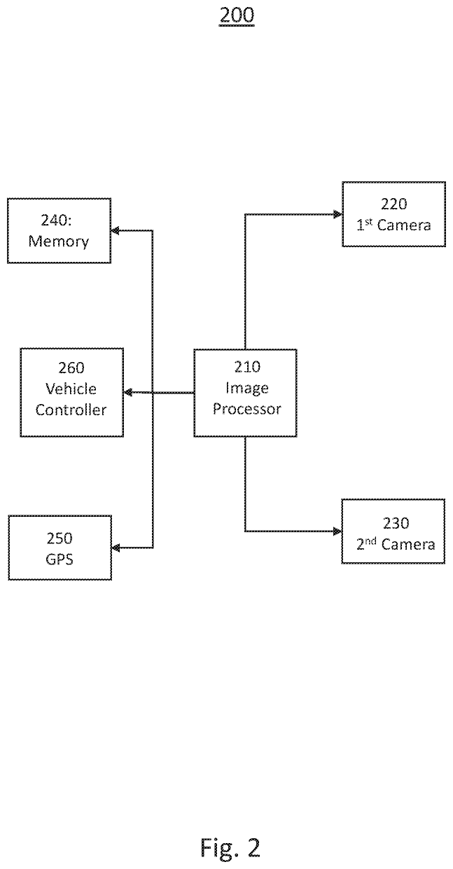

Turning now to FIG. 2, a block diagram illustrating an exemplary system for object detection in camera blind zones in a motor vehicle 200 is shown. The exemplary system comprises an image processor 210, a first camera 220, a second camera 230, a global positing signal (GPS) sensor 250, a memory 240, and a vehicle controller 260. The first camera 220 and second camera 230 may be mounted at different locations on the vehicle wherein each of the first camera 220 and the second camera 230 have a forward looking view. The first camera 220 may be a high dynamic range camera, an infrared camera, or the like. A high dynamic range camera is capable of imaging with a greater range of luminosity that a limited exposure range, or standard dynamic range, camera. An infrared camera, or thermographic camera generates a heat zone image using infrared radiation. In this exemplary embodiment, the second camera 230 may be a standard dynamic range camera to reduced costs of the overall system, but optionally may also be a high dynamic range camera or the like.

The image processor 210 is operative to receive images from the first camera 220 and the second camera 230. The image processor 210 may combine these images into a single image with a high dynamic range or may process the two images individually and transmit the information to the vehicle controller 260. The image processor 210 is further operative to generate control signals to couple to each of the first camera 220 and the second camera 230 in order to adjust the parameters of the cameras. For example, the image processor 210 may determine from prior images that a dark zone is approaching in the distance wherein the current settings of the cameras are unable to detect objects with the dark zone. The image processor 210 may then generate a control signal to instruct the first camera 220 to adjust its detection range or sensitivity in order to detect objects within the dark zone at the expense of not detecting objects within a bright zone. The objects within the bright zone will continue to be detected by the second camera 230.

In another exemplary embodiment, the image processor 210 may receive a data signal from the vehicle controller 260 indicative of a loss of tracking of an object entering a bright zone, such as leaving a tunnel. The image processor 210 may then generate a control signal instructing the first camera 220 to change sensitivity or other parameters in order to detect objects within the bright zone. The vehicle controller 260 is then operative to receive either a high dynamic range image, a pair of images, or data indicative of objects within the field of view of the cameras and to track objects proximate to the vehicle. In assisted driving system equipped vehicles, the vehicle processor is then operative to control the vehicle in response to the tracked objects among other factors. In some exemplary embodiments, the vehicle processor 260. may perform the tasks of the image processor 210. In some instances, a vehicle controller may be used to receive commands from the vehicle processor to control the steering, acceleration, and braking of the vehicle.

In another exemplary embodiment, the image processor 210 is operative to receive an image from the first camera 220. The image processor 210 may receive data from the vehicle controller 260 indicative of a camera blind spot notification. The camera blind spot notification may be generated in response to a GPS data and/or vehicle velocity data indicating a possible camera blind sport, such as entering a tunnel, exiting a tunnel, or approaching another known blinds spot, such as an area of dark shadows or the like. The notification may be further made in response to time of day, date, weather, or the like, which may be indicative of a probably blind sport for vehicular cameras. Alternatively, the vehicle controller 260 may retrieve information from the memory 240 indicative of a location of a known blind sport. The vehicle controller 260 may combine GPS information, stored information and time of day information in generating the blind spot notification.

The image processor 210 is operative to receive the blind spot notification from the vehicle controller 260 and to generate a control signal to change a parameter on the first camera 220. The parameter may include luminance range, exposure, spectral band, or the like, and is changed to compensate for the indicated potential blind spot. The image processor 210 may then be operative to receive a first image from the first camera 220 and, optionally, a second image from the second camera 230, generate a high dynamic range image in response to the received images and to couple this image to the vehicle controller 260. The vehicle controller 260 is then operative to control the driving assisted vehicle in response to the image wherein the camera parameters have been adjusted to compensate for the potential blind spot.

In some instances, vehicular cameras may report incorrect object information when target enters/exits tunnel due to rapid changes in lighting conditions. The proposed system is operative to leverage tunnel localization from received GPS data and/or stored map data to track or infer objects entering or existing heavily shaded or blind spots, such as tunnels or building shadows and to proactively adjust tracking and fusion to obtain optimized final fusion result. The exemplary system uses onboard map and GPS information and other sensors to obtain information about tunnel, traffic/weather in order to predict and determine tracked target entering or exiting tunnel. The system may be responsive to detect large deviation of camera detection vs other sensors at the expected location and time and to adjust the camera parameters or tracking information in response. Additionally, the system may adjust tracking and fusion to minimize impact of temporary sensor detection error and optimize multi-sensor object detection with ground truth information.

The map data and GPS information may be used to estimate a distance to tunnel entrance, distance to tunnel exit, road incline and locations of visual obstructions. In addition the GPS and map data may be used to determine height, width, curvature profile of a roadway lane, number of lanes and the host lane location. The location information may be used to correlate target localization and tunnel entrances and exits. The cameras and other sensors may be used for object tracking and image fusion wherein the camera aperture may be adjusted for whiteout conditions, image saturation, over exposure, and/or underexposure. The system may be initiated in response to a detection of large deviations between object localization in response to camera detection and other sensors and facilitating an adjustment in tracking and fusion KF covariance in order to minimize error input to improve tracking and fusion performance.

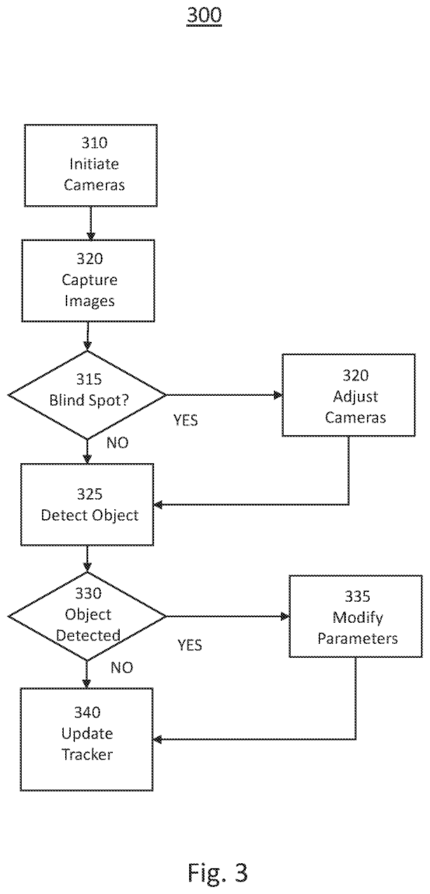

Turning now to FIG. 3, a flow chart illustrating an exemplary method 300 for object detection in camera blind zones in a motor vehicle motor vehicle is shown. The exemplary method 300 is first operative to initiate the first camera and the second camera 310 in response to a command from the vehicle controller. The command may be issued in response to an activation of an assisted driving feature of the vehicle or in response to an activation of the vehicle.

The method is then operative to capture at least a first image from the first camera 320. The method is then operative to determine if a potential camera blind spot may be in the image in response to a GPS signal or location data stored on a memory. If a blind spot is suspected, the method is then operative to adjust at least one of the camera parameters 320, such as ISO, aperture or exposure. This will result in an adjustment in the luminance received by the camera detector or the range of luminance detected. The method then captures at least a first image from the first camera 310. If no region of high luminance contrast is not detected 325, the method is then operative to detect an object within the image 325. If an object is detected, the method is then operative to modify the object tracking parameters 335, such as object velocity, trajectory, etc. The method is then operative to update the tracker 340 and return to capture another image 310. If no object is detected, the tracker is updated 340 and the method is operative to capture another image 310.

It should be emphasized that many variations and modifications may be made to the herein-described embodiments, the elements of Which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context dearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. An apparatus comprising:
a first camera having a first adjustable parameter having a first setting and a second setting for capturing a first image at the first setting and a second image at the second setting;
a second camera for capturing a third image at the first setting;
a processor for receiving a location information indicative of a blind spot, generating a first control signal to adjust the first adjustable parameter from the first setting to the second setting in response to the location information, fusing the second image and the third image to generate a fused image, detecting an object within the fused image and generating a second control signal in response to the object; and
a vehicle controller for controlling a driving assisted vehicle in response to the second control signal.

2. The apparatus of claim 1 wherein the blind spot is an area of low luminance.

3. The apparatus of claim 1 wherein the first adjustable parameter is an exposure time.

4. The apparatus of claim 1 wherein the first adjustable parameter is a sensitivity.

5. The apparatus of claim 1 wherein the first adjustable parameter is a range of luminosity.

6. The apparatus of claim 1 wherein the location information indicative of a blind spot is determined in response to a global positing system signal.

7. The apparatus of claim 1 further comprising a second camera wherein the second camera is an infrared camera.

8. A method comprising:
receiving a request for an activation of an assisted driving algorithm;
capturing a first image with a first camera;
receiving a location data;
comparing the location data with a location stored in a memory;
adjusting a first parameter on the first camera in response to the location;
capturing a second image with the first camera;
capturing a third image with a second camera;
fusing the second image and the third image to generate a fused image;
detecting an object within the fused image; and
controlling a vehicle in response to the detection of the object.

9. The method of claim 8 wherein the location is indicative of an area of low luminance.

10. The method of claim 8 wherein the parameter is an exposure time.

11. The method of claim 8 wherein the parameter is a sensitivity.

12. The method of claim 8 wherein the parameter is a range of luminosity.

13. The method of claim 8 wherein the location stored in the memory is indicative of a camera blind spot.

14. The method of claim 8 wherein the third image is an infrared image.

15. An apparatus comprising:
a first camera having an adjustable dynamic range for capturing a first image and a third image;
a second camera for capturing a second image;
a global positing sensor for determining a current location;
an image processor comparing the current location to a stored location, the image processor further configured for generating a control signal for adjusting the adjustable dynamic range in response to the comparison and controlling the capture of the third image, fusing the second image and the third image to generate a fused image, detecting an object within the fused image; and
a vehicle controller for controlling a vehicle in response to the object.

16. The apparatus of claim 15 wherein the first camera is a high dynamic range camera

17. The apparatus of claim 15 wherein the adjustable dynamic range adjusts an exposure time.

18. The apparatus of claim 15 wherein the adjustable dynamic range adjusts a sensitivity of the first camera

19. The apparatus of claim 15 wherein the stored location is indicative of a blind spot.

20. The apparatus of claim 15 wherein the stored location is indicative of a tunnel.
